(19) United States
(12) Patent Application Publication
(10) Pub. No.: US 2026/0310984 A1
(43) Pub. Date: Oct. 8, 2026

(54) KNOWLEDGE TRANSFER BETWEEN LANGUAGE MODELS

(71) Applicant: Raytheon Company, Arlington, VA (US)

(72) Inventors: Joshua A. Binkley, Richardson, TX (US); Maleehah Zafar, Ashburn, VA (US); Frederick E. Bernardin, Somerville, MA (US); Christine R. Nezda, Richardson, TX (US)

(21) Appl. No.: 19/173,450

(22) Filed: Apr. 8, 2025

(51) Int. Cl. G06N 3/096; G06F 16/2458; G06N 3/042; G06N 3/0475

(52) U.S. Cl. CPC G06N 3/096; G06F 16/2462; G06N 3/042; G06N 3/0475

(57) ABSTRACT

Devices, systems, machine-readable media, and methods for knowledge transfer between language models. A method includes receiving input data, the input data indicating a user-defined domain, extracting, by a large language model and based on the input data and an upper-level ontology, a first domain element that is an example of an entity of the upper-level ontology, appending the first domain element to a domain ontology resulting in a knowledge base, extracting, by the large language model and based on the input data and the first domain element, a second domain element, appending the second domain element to the knowledge base to form an expanded knowledge base, selecting a small language model, and transferring knowledge from the expanded knowledge base to the small language model resulting in a domain-specialized small language model.

### TECHNICAL FIELD

Embodiments discussed herein regard devices, systems, machine-readable media, and methods in the field of language models. Embodiments provide transfer of knowledge between language models.

### BACKGROUND

A large language model can be designed to process and generate human-like text by training on very large data sets. The large language model can be trained on textual information, enabling the large language model to recognize and reproduce complex language patterns through patterns identified during a training phase. The training can enable the large language model to perform various tasks, such as, text composition, content summarization, language translation, and interactive question-answering.

The use of the large language model can span multiple industries and use cases. For example, the large language model can be used in customer service as a chat bot and an automated support system that can engage in conversation with users. The large language model can also aid in content creation, assisting in generating various forms of written content, such as, an article or a blog post. In the software development domain, the large language model can assist a developer in writing code and aid in a debugging process.

### BRIEF DESCRIPTION OF THE DRAWINGS

FIG. 1 illustrates, by way of example, a diagram of a knowledge base generation process.

FIG. 2 illustrates, by way of example, a user input interface.

FIG. 3 illustrates, by way of example, a prompt template and a prompt template that has been populated to form a prompt.

FIG. 4 illustrates, by way of example, an output from a prompt.

FIG. 5 illustrates, by way of example, a diagram of a knowledge transfer process through inference.

FIG. 6 illustrates, by way of example, a diagram of a knowledge transfer process through training.

FIG. 7 illustrates by way of example, a flow diagram of an embodiment of a method for knowledge transfer between language models.

FIG. 8 illustrates, by way of example, a machine learning (ML) engine for training a ML model.

FIG. 9 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

A large language model can possess a capability to process a vast amount of data to generate human-like responses to prompts or queries. However, a foundational large language model can present an implementation challenge due to extensive computational requirements, a large hardware footprint, or a combination thereof. A computational or size constraint can make a foundational large language model impractical for deployment on, for example, an edge device or in a multi-agent compute environment.

Utilizing a small language model on an edge device or in a multi-agent compute environment can offer a potential solution to the limitations of a large language model. For example, a small language model can operate on a device with limited resources and function remotely without constant server access. A small language model can also provide responses at a faster rate due to reduced processing and model size requirements.

However, conventional approaches for enabling domain-specialized knowledge in small language models rely on manual curation of in-domain datasets to enable effective training and use of the small language model. The traditional methods of training and using the small language model can be expensive and unreliable due, at least in part, to the manual curation process or the lack of training datasets.

The present disclosure provides systems and methods that address the technical challenges associated with time-consuming and unreliable manual curation of in-domain datasets for training small language models. This approach implements an automated process that leverages an upper-level ontology framework to extract parametric domain-specialized information from a foundational large language model through the use of prompts. The parametric knowledge extracted from the foundational large language model can be used to populate a domain ontology to create a domain-specialized knowledge base.

The ontological relationships in the domain knowledge of the domain-specialized knowledge base can be transferred to a small language model through an inference process or a training process. At inference time, the transfer of the domain-specialized knowledge base can be through a technique that is a standard in the industry, such as, retrieval augmented generation (RAG). At training time, the transfer of the domain-specialized knowledge base can be through an established technique, such as, fine-tuning, knowledge distillation, prompt engineering, or the like. After the domain knowledge is transferred, the small language model can be considered to be domain-specialized or a domain-specialized small language model. The domain-specialized small language model can be deployed in a multi-agent compute environment or an edge device without reliance on the foundational large language model. The automated process of the present disclosure can generate structured data for transfer to a small language model, providing a scalable solution for knowledge transfer between language models without reliance on manual data curation.

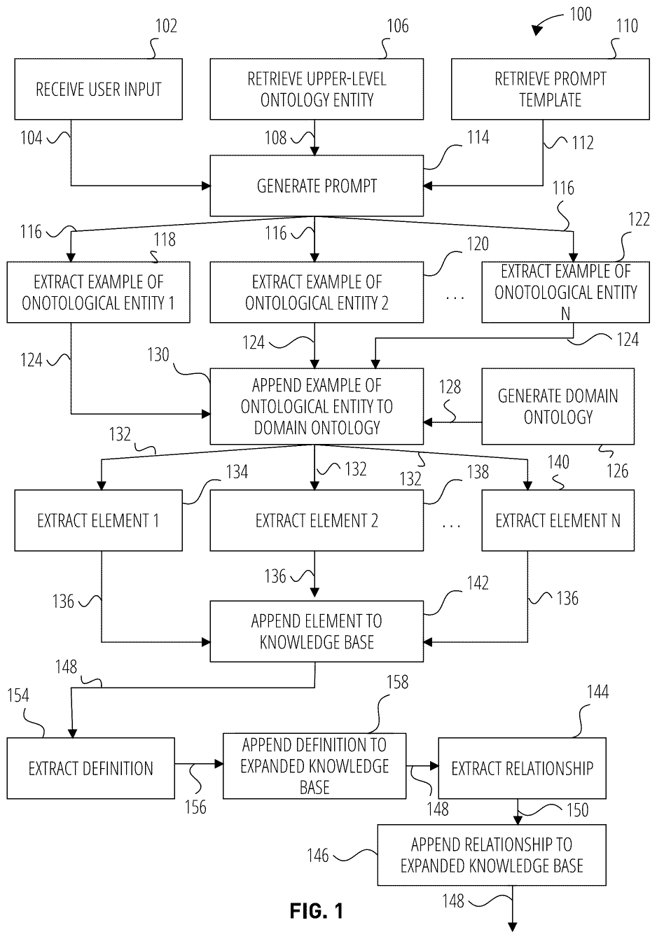

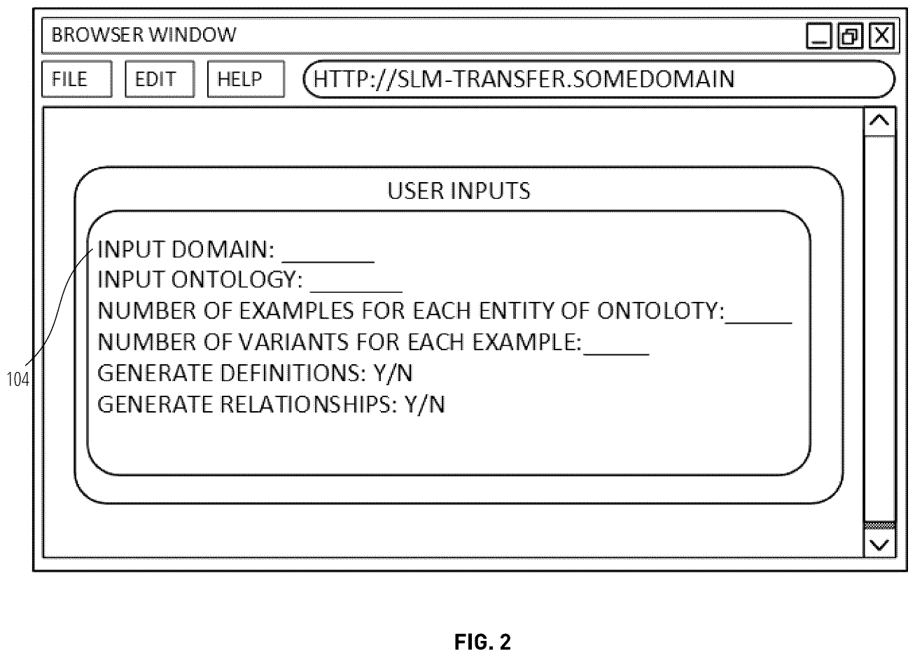

FIG. 1 illustrates, by way of example, a diagram of a knowledge base generation process 100. The knowledge base generation process 100, as illustrated, includes a receive user input operation 102. A user domain input 104, received at the user input operation 102, can include a user-specified domain. The domain can refer to a specialized area of knowledge or expertise that a language model is trained on or specialized for. The user domain input 104 can determine the resultant domain-specialized small language model that can be deployed as a multi-agent compute environment or on an edge device. An example of a domain for a language model can include, but is not limited to, general language, medical and healthcare, legal, finance, economics, science and research, geopolitics, foreign policy, programming and software development, media and journalism, entertainment, or the like. The user domain input 104 can serve as an input to a generate prompt operation 114. In some examples, the receive user input operation 102 can include one or more parameters including, but not limited to, an input ontology, a number of examples for each entity of the ontology, a number of variants for each example, an instruction to generate definitions, an instruction to generate relationships, or the like. FIG. 2 illustrates, by way of example, a user input interface.

The knowledge base generation process 100 can include a retrieve upper-level ontology entity operation 106. An upper-level ontology, or a foundational ontology, is a high-level abstract framework that can define general concepts that apply across multiple domains. An upper-level ontology can provide a common structure integrating and organizing information in a consistent way. An example of an upper-level ontology can include, but is not limited to, Basic Formal Ontology (BFO), Descriptive Ontology for Linguistic and Cognitive Engineering (DOLCE), Suggested Upper Merged Ontology (SUMO), General Formal Ontology (GFO), Common Algebraic Specification Language (CASL), or the like.

The upper-level ontology defines general concepts, such as, object, process, time, space, relation, entity, event, property, attribute, or the like, which can be applied across a variety of different domains. The upper-level ontology can include an entity that is a fundamental unit or knowledge representation. In the context of an ontology, an entity can be any object, concept, or occurrence that can be formally defined and related to other entities within the system. The entity can form the building block of structured knowledge, allowing for categorization, reasoning, or automated inference. An example of an entity in an upper-level ontology can include, but is not limited to, a concrete entity, an abstract entity, an event, a process, or a relation. The retrieve upper-level ontology entity operation 106 can retrieve an upper-level ontology entity 108 that can serve as an input into the generate prompt operation 114.

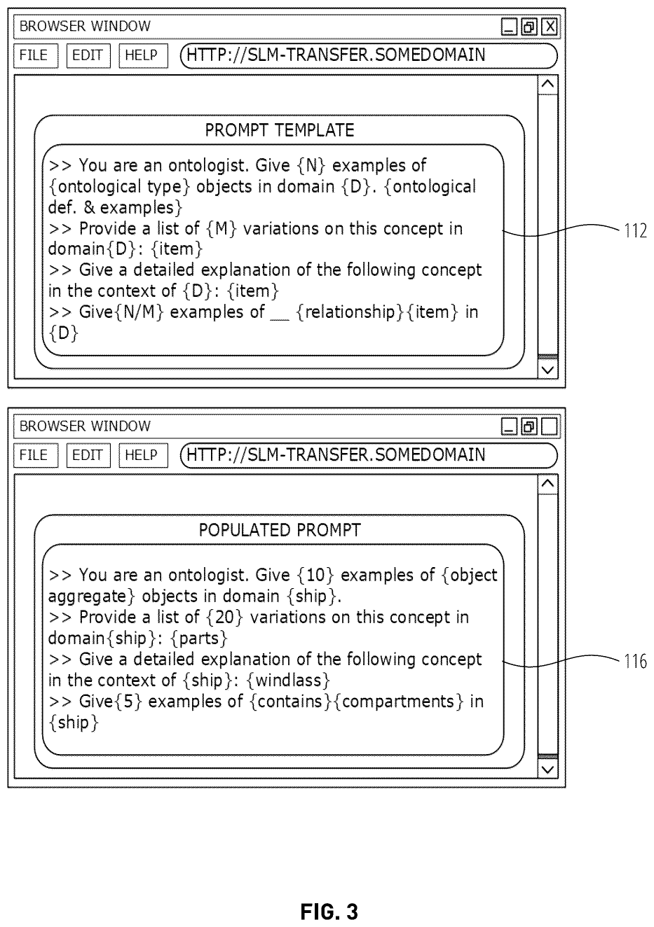

The knowledge base generation process 100 can include a retrieve prompt template operation 110. The prompt template 112 can be retrieved from a list of pre-defined prompts for input into a language model. The prompt template 112 can be structured to provide examples of objects in a domain, provide a list of variations on a concept in a domain, provide a detailed explanation of a concept in the context of a domain, provide an example of a relationship between two elements or entities in a domain, or the like. FIG. 3 illustrates, by way of example, a prompt template 112. In some examples, the prompt template can include a prompt: “you are an ontologist, Give {N} examples of {ontological type} objects in domain {D}. {ontological def. & examples}”, “Provide a list of {M} variations on this concept in domain {D}: {item}”, “Give a detailed explanation of the following concept in the context of {D}: {item}”, “Give {N/M} examples of {relationship} {item} in {D}”, “Give {N/M} examples of {item} {relationship} in {D}”, or the like.

The retrieve prompt template operation 110 can retrieve a prompt template 112 that can serve as an input into the generate prompt operation 114.

The generate prompt operation 114 can concatenate, insert, or link the user domain input 104 and the upper-level ontology entity 108 into the prompt template 112 to generate a prompt 116 for input into a large language model. The generate prompt operation 114 can be automated with minimal or no human supervision.

The large language model can include a foundational large language model that is a broad, general-purpose model designed to serve as a base model for various applications. The large language model can be fine-tuned or adapted for specialized use cases in a downstream application. An example of a large language model can include, but is not limited to, ChatGPT developed by OpenAI, Claude developed by Anthropic, Gemini developed by Google DeepMind, DeepSeek developed by DeepSeek AI, Mistral 7B developed by Mistral AI, LLaMA3 developed by Meta, Bloom 176B developed by BLOOM, MPT-30B developed by MPT Models or the like.

The prompt 116 can include a query to a large language model to extract an example of an upper-level ontology entity 108 based on the domain specified in the user domain input 104. In some examples, the prompt 116 can extract one example of an upper-level ontology entity 108, one example each of multiple upper-level ontology entities 108, multiple examples of one upper-level ontology entity 108, or multiple examples of multiple upper-level ontology entities 108. The extraction of one or more examples of the upper-level ontology entity 108 can be extracted from operations 118, 120, and 122. While FIG. 1 shows only three exemplary operations 118, 120, and 122, a person skilled in the art can understand that the extraction of an example corresponding to an upper-level ontology entity 108 is not limited to only three examples but can include up to or more than the number of entity types present in an upper-level ontology. In some examples, the prompt 116 can include a query to the large language model to provide a predetermined number of examples for one upper-level ontology entity 108. In some examples, the prompt 116 can include a query to the large language model to provide one example for a predetermined number of upper-level ontology entities 108.

In some examples, the prompt 116 can include an element definition, an out of domain example of the element, a request to create a pre-determined number of examples of the element in the domain to provide additional context for generation of examples. The prompt 116 can include a single prompt 116 or multiple prompts 116 that are that are combined together to form a complex or comprehensive prompt 116. The combined prompts 116 can work in sequence or in parallel to generate the desired output from the knowledge base generation process 100. FIG. 3 illustrates, by way of example, a prompt template 112 that has been populated to form a prompt 116.

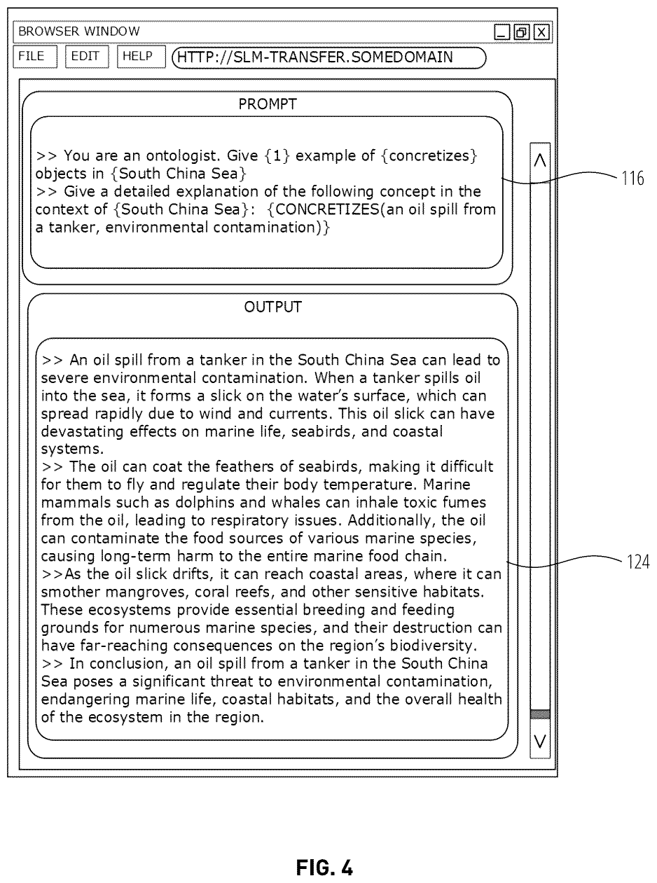

The output of the operations 118, 120, and 122 can be one or more domain elements 124. FIG. 4 illustrates, by way of example, an output from a prompt 116, where the output can function as a domain element 124. The domain element 124 can be an element to be incorporated within a knowledge base being developed through the knowledge base generation process 100.

The domain element 124 can serve as an input into an append example of ontological entity to domain ontology operation 130. The append example of ontological entity to domain ontology operation 130 can also include an input of a domain ontology 128. The domain ontology 128 can be generated in a generate domain ontology operation 126. A domain ontology 128 can include an ontology that defines concepts, relationships, entities, and the like, within a specialized area of knowledge or industry. Unlike an upper-level ontology which provide general, abstract categories applicable to all domains, a domain-level ontology can focus on a specialized field and organize knowledge relevant to a selected domain. An example of a domain ontology can include, but is not limited to, International Classification of Diseases (ICD) for classifying diseases and health conditions; Gene Ontology (GO) for classifying genes, proteins, and biological processes; Financial Industry Business Ontology (FIBO) for standardizing financial instruments, institutions, and regulations; Legal Knowledge Interchange Format (LKIF) to define legal terms and concepts; MITRE ATT&CK Framework to describe cyber threats, attack techniques, and defense strategies; Systematic Sensor Network Ontology (SSN) to represent sensor data; Learning Object Metadata (LOM) for defining educational resources and metadata structures; or the like.

The domain element(s) 124 can be appended to the domain ontology 128 to generate a knowledge base 132 through the append example of ontological entity to domain ontology operation 130. As mentioned, the domain element 124 can include multiple domain elements 124 from the operations 118, 120, and 122 to be appended to the domain ontology 128 to form the knowledge base 132. The knowledge base 132 can be implemented using various data structures, including, but not limited to, relational databases, graph databases, hierarchical tree structures, semantic networks, distributed hash tables, or the like.

In some examples, the append example of ontological entity to domain ontology operation 130 can extend a pre-existing domain ontology 128. In examples, the pre-existing domain ontology 128 can contain one or more domain elements 124 that are pre-populated prior to the knowledge base generation process 100. The operations 118, 120, and 122 can be applied to identify and append additional domain elements 124 to the pre-existing domain ontology 128. This approach can allow users to build on existing curated information in the pre-existing domain ontology, expanding the pre-existing domain ontology with relevant domain-specialized elements. In examples, the pre-existing domain ontology 128 can include an industry-specific taxonomy, a standardized vocabulary, a public ontology repository, a scientific classification system, a regulatory framework, an enterprise data dictionary, a semantic web ontology, a professional glossary, a technical specification, an international standard, a cross-domain knowledge base, a specialized research ontology, or the like.

The knowledge base generation process 100 can take further operations to generate element 136 through extract element operations 134, 138, and 140. While FIG. 1 shows only three operations 134, 138, and 140, a person skilled in the art can understand that extraction of an element 136 is not limited to only three examples, but can include more than three examples. In the extract element operations 134, 138, and 140, the large language model can be directed to extract objects similar to the domain element 124. The large language model can be directed to provide a list of a predetermined number of variations of the domain element 124 in the domain of the user domain input 104. While described for the extraction of objects similar to the domain element 124, the operations 134, 138, and 140 can be applied to a variety of different upper-level ontology entities 108. For example, the operations 134, 138, and 140 can be applied to extract additional examples, variations, instances, classes, properties, axioms, events, processes, categories, taxonomies, or the like, related to an individual domain element 124. The operations 134, 138, and 140 can also be applied for each individual domain element 124 generated as a result of the operations 118, 120, 122. For example, if operations 118, 120, and 120 generated ten domain elements 124, each of the individual domain elements 124 can result in their own examples, variations, instances, classes, properties, axioms, events, processes, categories, taxonomies, or the like through operations 134, 138, and 140.

The operations 134, 138, and 140 can also be recursive in nature. For each of the elements 136 produced as initial outputs from operations 134, 138, and 140, the elements 136 can be used as inputs for subsequent iterations of operations 134, 138, and 140. The iteration of operations 134, 138, and 140 can further generate additional examples, variations, instances, classes, properties, axioms, events, processes, categories, taxonomies, or the like, for each element 136.

After the operations 134, 138, and 140, the elements 136 can be appended to the knowledge base 132 to form an expanded knowledge base 148 through the append element to knowledge base operation 142. The append element to knowledge base operation 142 is not limited to appending only elements 136, and can include one or more of the domain elements 124 or any of the examples, variations, instances, classes, properties, axioms, events, processes, categories, taxonomies, or the like, mentioned above.

The expanded knowledge base 148 can be an input to the extract definition operation 154. The extract definition operation 154 can direct the large language model to provide a definition 156 for each of the domain elements 124 or elements 136 generated in operations 118, 120, 122, 134, 132, or 140. A definition 156 is a formal specification of the meaning of a concept within an ontology. The definition 156 can include, but is not limited to, an informal definition, a formal definition, a necessary and sufficient condition, a lexical definition, an operation definition, or the like. The definition 156 generated or extracted by the extract definition operation 154 can be appended to the expanded knowledge base 148 to further enrich the expanded knowledge base 148 with new definitional content.

The expanded knowledge base 148 can be an input to the extract relationship operation 144. The extract relationship operation 144 can direct the large language model to provide a relationship 150 between two or more domain elements 124, elements 136, or definitions 156 in the expanded knowledge base 148. A relationship 150 is a formally defined connection between two or more entities or elements within an ontology. The relationship 150 can define how entities or elements interact, associate, or relate to each other, and can enable structured reasoning and knowledge representation. The relationship 150 can include, but is not limited to, an object property that describes entity-to-entity relationships, a data property that describes entity-to-literal relationships, a hierarchical relationship that is taxonomy-based, a casual and dependency relationship, an associative relationship, or the like. For example, the relationship 150 can define how a domain element 124 interacts with one or more other domain elements 124, how a domain element 124 interacts with one or more of elements 136, how a domain element 124 interacts with one or more of definitions 156, how an element 136 interacts with one or more other elements 136, how an element 136 interacts with one or more definitions 156, how a definition 156 interacts with one or more other definitions 156, or the like. The relationship 150 generated or extracted by the extract relationship operation 144 can be added to the expanded knowledge base 148 to further enrich the expanded knowledge base 148 with new relational content.

In an example, the knowledge base generation process 100 can receive a user domain input 104 that specifies a domain D through the receive user input operation 102. The generate prompt operation 114 can create a prompt 116 requesting a large language model to produce, extract, or generate N examples as domain elements 124 for each of the O upper-level ontology entities 108 of elements in domain D. The domain elements 124 can include both objects and relationships.

The prompt 116 can feed into multiple extract example of ontological entity operations 118, 120, and 122 to extract N*O domain elements 124 in domain D. The output domain elements 124 can be appended to a domain ontology 128 or similar data structure to form a knowledge base 132.

Subsequently, for each of the N*O domain elements 124 returned by the operations 118, 120, and 122, another prompt can request the large language model generate M variations or elements 136 related to the domain element 124, resulting in a total of N*O*M elements 136. The elements 136 can be appended to the knowledge base 132 through the append element to knowledge base operation 142, creating an expanded knowledge base 148.

The knowledge base generation process 100 can continue with an extract definition operation 154. The extract definition operation 154 can generate or extract definitions 156 for each of the N*O*M domain elements 124 and elements 136 in the expanded knowledge base 148. The definitions 156 can be subsequently appended to the expanded knowledge base 148. The extract relationship operation 144 can generate or extract relationships between the N*O*M domain elements 124 and elements 136. The relationships can be between the N*O*M domain elements 124, elements 136, and the definitions 156, or between definitions 156. The relationships 150 can be appended to the expanded knowledge base 148.

The knowledge base generation process 100 can offer advantages over traditional manual data curation methods. By removing or limiting the need for manual data curation, the knowledge base generation process 100 can remove or limit both cost or unreliability associated with human-driven data collection and organization. The unreliability of manual data curation can be limited or removed by leveraging hierarchical relationships defined by an upper-level ontology. The upper-level ontology can contain artifacts capable of expressing objects, examples, elements, definitions, relationships, and the like, to aid in structuring data within a domain of interest.

The knowledge base generation process 100 can be fully automated, enabling systemic extraction of parametric knowledge related to a domain. The automation of the knowledge base generation process 100 can be beneficial when dealing with large-scale data generation. For example, the knowledge base generation process 100 can generate or extract thousands, tens of thousands, or hundreds of thousands of elements related to the domain from a large language model. The recursive nature of the knowledge base generation process, combined with the guidance of an upper-level ontology and support from a large language model, can allow the knowledge base generation process 100 to operate with minimal human supervision. The minimal human supervision can reduce the resource requirements typically associated with conventional manual or human-supervised knowledge base creation.

The knowledge base generation process 100 can also produce structured data rather than a limited set of manually created parameters. The structured output can be beneficial as the structured output can create an organized knowledge base that can be readily utilized for various applications. The knowledge base 132 or the expanded knowledge base 148 can maintain consistency and completeness through the automated generation process, while leveraging the capabilities of the upper-level ontology to ensure proper relationship mapping and domain representation.

The knowledge base generation process 100 can also offer a cost advantage to traditional methods. For example, the approach of extracting parametric data from a large language model and transferring that knowledge to a small language model can be more economically efficient than training a small language model using a manually curated domain-specialized dataset. The cost efficiency can stem from eliminating or limiting extensive resources typically required for manual data collection, validation, and curation processes. By leveraging the pre-existing knowledge within a large language mode and systematically transferring the knowledge through an automated knowledge base generation process 100, costs can be reduced or eliminated during the domain-specialized small language model development process.

In some examples, the expanded knowledge base 148 can have applications beyond knowledge transfer between a large language model and a small language model. The expanded knowledge base 148 can be utilized across various business functions and applications. For example, the expanded knowledge base 148 can be employed for semantic search and recommendation systems, enabling more intelligent information retrieval and content suggestions. The expanded knowledge base 148 can also be used for supply chain management operations by providing structured, domain-specialized knowledge to support decision-making and process optimization.

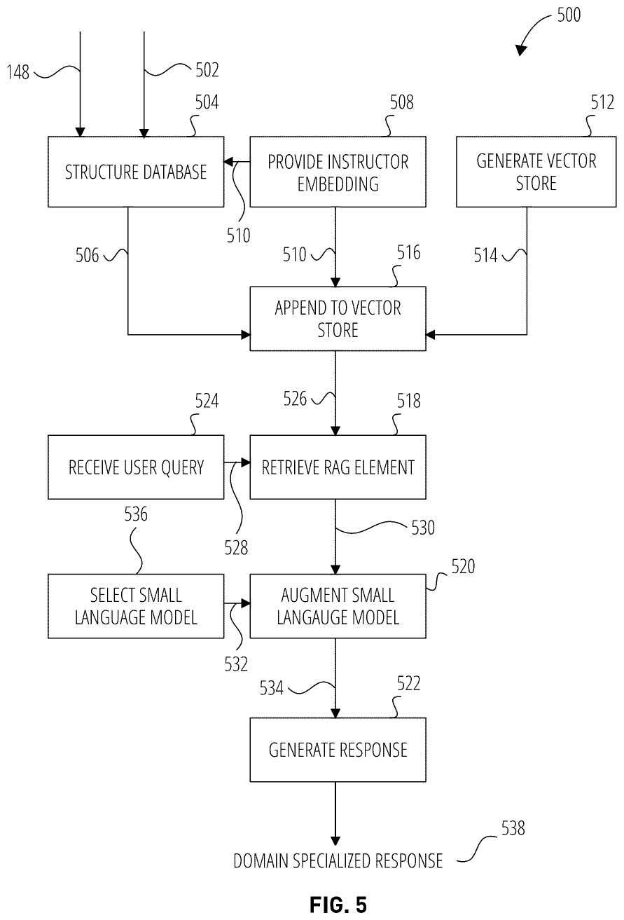

FIG. 5 illustrates, by way of example, a diagram of a knowledge transfer process through inference 500. The knowledge transfer from a large language model to a small language model 532 can effectively specialize the small language model for use in a domain to a domain-specialized model 534. The domain-specialized model 534 can be adapted to the domain of interest through this knowledge transfer. The expanded knowledge base 148 of FIG. 1 can serve as an input into a structure database operation 504. Data input 502 and an instructor embedding 510 can also serve as an input into the structure database operation 504. An example of a data input 502 can include, but is not limited to, textual data, an image, a multimedia content, an external contextual information, a domain-specialized embedding, a text from a database, a text from an API, a research paper, an article, a book, a web page, a news article, a social media post, or the like. In some examples, the knowledge transfer process through inference 500 can select from one or more expanded knowledge bases 148 based on a user query 528, each of the one or more expanded knowledge base 148 containing its own domain-specialized knowledge.

In the structure database operation 504, the expanded knowledge base 148 and data input 502 can be structured to enable retrieval of relevant information in response to a user query. The expanded knowledge base 148 and data input 502 can be divided into knowledge chunks, with each knowledge chunk representing a self-contained segment of knowledge. In some examples, the expanded knowledge base 148 can be segmented into knowledge chunks based on entities within the expanded knowledge base 148. Each of the knowledge chunks can be associated with metadata annotations that can enhance retrieval efficiency and filtering capabilities. The metadata annotation can include, but is not limited to, identifiers such as title, categorical tags, hierarchical relationships to other knowledge chunks, contextual attributes that further specify the nature of the contained information, or the like. In some examples, the definitions 156 and relationships 150 generated or extracted in the knowledge base generation process 100 can serve as metadata annotations in the structure database operation 504.

The knowledge chunks of the expanded knowledge base 148 and data input 502 can undergo a vectorization process as part of the structure database operation 504. In the vectorization process, the textual content of the knowledge chunk can be converted into a high-dimensional vector representation. In some examples, the vectorization process can be performed using a vector embedding model trained to encode semantic meaning, such that textual similarity can be effectively measured through mathematical distance metrics. The mathematical distance metrics can include, but are not limited to, a cosine similarity, a Euclidean distance, a dot product, or the like. In some examples, the expanded knowledge base 148 can be sufficiently structured due to the knowledge base generation process 100. The output of the structure database 504 can include a vectorized knowledge base 506.

The knowledge transfer process through inference 500 can include a provide instructor embedding operation 508. An instructor embedding 510 can be a type of vector embedding used in a retrieval augmented generation (RAG) process that can be designed for information retrieval tasks. The instructor embedding 510 can enhance the vectorization process in the structure database operation 504 by creating semantically meaningful representation of the knowledge chunks, leading to more accurate and contextually relevant query responses. The output of the provide instructor embedding operation 508 can be an instructor embedding 510. In some examples, the instructor embedding 508 can be used to transform the expanded knowledge base 148 into a vector representation for subsequent retrieval.

The knowledge transfer process through inference 500 can include a generate vector store operation 512. A vector store 514 can be a specialized database designed to store and retrieve high-dimensional vector representations of data. The vector store 514 can leverage an approximate nearest-neighbor (ANN) search algorithm to retrieve the most semantically similar data points to a given query. The vector store 514 can include, but is not limited to, a dedicated vector database, a hybrid vector and traditional database, an embedded vector store in an artificial intelligence platform, or the like. The output of the generate vector store operation 512 can include a vector store 514.

The vectorized knowledge base 506, the instructor embedding 510, and the vector store 514 can serve as inputs to an append to vector store operation 516 to append the vectorized knowledge base 506 and the instructor embedding 510 to the vector store 514, resulting in an augmented vector store 526. The generation of the augmented vector store 526 can be recursive. For example, one or more augmented vector stores 526 can be generated based on the one or more expanded knowledge bases 148.

When a user query 528 is received by the receive user query operation 524, the knowledge transfer process through inference 500 can retrieve a RAG element 530 through the retrieve RAG element 518 operation to access relevant information from the augmented vector store 526. The RAG element 530 can then serve as an input for a small language model 532, the small language model 532 selected through the select small language model operation 536. By incorporating the RAG element 530 into the small language model 532, the knowledge transfer process through inference 500 can create a domain-specialized small language model 534 tailored to the particular knowledge domain. The domain-specialized small language model 534 can generate a targeted domain-specialized response 538 to the user query 528, ensuring the response is contextually relevant to the specialized domain. In some examples, upon receipt of the user query 528, the knowledge transfer process through inference 500 can select from one or more augmented vector stores 526 according to the domain-specialized knowledge that is required by the user query 528.

The knowledge transfer process through inference 500 can enable the small language model 532 to be enhanced with domain-specialized knowledge that was parametrically extracted from a large language model. The knowledge transfer process through inference 500 can be efficient as the process does not require retraining of the small language model 532. The knowledge transfer process through inference 500 can allow the small language model 532 to act as a domain-specialized small language model 534 in a specialized domain, representing a fraction of the large language model knowledge base.

The knowledge transfer process through inference 500 can enable domain-specialized knowledge to be transferred from the expanded knowledge base 148 to a small language model 532 deployed at an edge device. The deployment of domain-specialized knowledge to the small language model 532 can allow the small language model 532 to access domain-specialized knowledge while providing a response to a domain-specialized user query 528 at an edge device more rapidly than obtaining a response from a large language model located at a central server. For example, a large language model can contain billions of parameters while a small language model 532 can be configured to operate with fewer parameters, from one hundred million to one billion parameters, while maintaining domain expertise. In some examples, a parameter count of the large language model can exceed a parameter count of the small language model by a factor of at least 10, by a factor of at least 100, by a factor of at least 1000, or by a factor of at least 10,000. The reduced parameter count of the small language model 532 can translate to a lower computational requirement and a faster inference time when compared to the large language model. For example, the domain-specialized small language model 534 can process a user query 528 locally on an edge device without the latency introduced by network communication with a central sever hosting the large language model. The smaller size of the domain-specialized small language model 534 can also mean a reduced memory requirement and a reduced power consumption when compared to the large language model.

Due to their smaller size, power, and compute requirements when compared to a large language model, the domain-specialized small language model 534 can be suited for edge device deployment. The domain-specialized small language model 534 can operate independently from the large language model due to the ability of the domain-specialized small language model 534 to access the domain-specialized expanded knowledge base 148. The independence of the domain-specialized small language model 534 from the large language model can enable the domain-specialized small language model 534 to operate in an environment where bandwidth or connectivity is limited. The independent nature of the domain-specialized small language model 534 can enable the domain-specialized small language model 534 to continue to function and provide a response even when network connection is lost.

The reduced size, power, and compute requirements of the domain-specialized small language model 534 can also enable deployment of the domain-specialized small language model 534 in a multi-agent compute environment, with the domain-specialized small language model 534 distributed across multiple devices. The distributed architecture can support various configuration options for hosting the domain-specialized small language model 534, the augmented vector store 526, and the expanded knowledge base 148. The various configurations can include a unified deployment where the domain-specialized small language model 534, the augmented vector store 526, and the expanded knowledge base 148 reside on the same device; a fully distributed deployment where the domain-specialized small language model 534, the augmented vector store 526, and the expanded knowledge base 148 are each hosted on separate individual devices; or a hybrid deployment where two of the domain-specialized small language model 534, the augmented vector store 526, and the expanded knowledge base 148 are hosted on one device, with the remaining of the domain-specialized small language model 534, the augmented vector store 526, or the expanded knowledge base 148 hosted on another device.

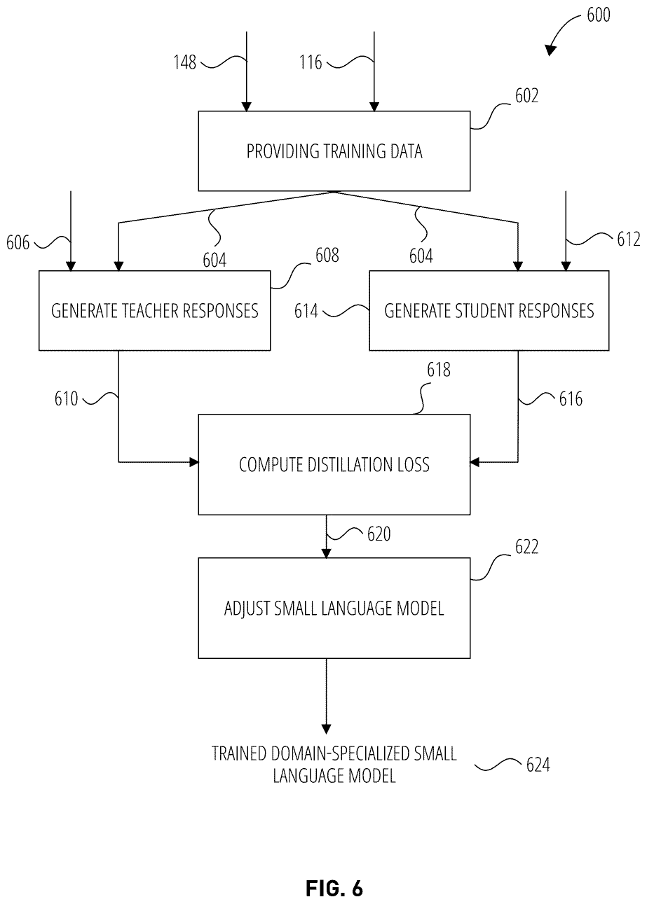

FIG. 6 illustrates, by way of example, a diagram of a knowledge transfer process through training 600. A small language model 612 can be trained to emulate the responses of a large language model 606 using examples from the expanded knowledge base 148 and prompts 116 through knowledge distillation techniques and a student-teacher model methodology. The knowledge transfer process through training 600 can include a providing training data operation 602 to provide training data 604 to a large language model 606 and a small language model 612.

The large language model 606 in the generate teacher responses operation 608 can generate a teacher response 610 to the training data 604. Similarly, the small language model 612 in a generate student responses operation 614 can generate a student response 616 to the training data 604. In some examples, the training data 604 can include the prompts 116, the expanded knowledge base 148, or a combination of both elements used in the knowledge base generation process 100 described earlier.

A compute distillation loss operation 618 can compute the distillation loss 620 between the teacher response 610 and the student response 616. The distillation loss 620 can quantify how well the small language model 612 mimics the behavior of the large language model 606. The distillation loss 620 measurement can incorporate a soft target indicating probability distributions of model outputs, a hard target indicating actual correct answers, or both. The distillation loss 620 can be calculated using various methods, including, but not limited to, a cross-entropy between a teacher probability distribution and a student probability distribution, a Kullback-Leiber divergence between the student response 616 and the teacher response 610, a mean squared error between the student response 616 and the teacher response 610, or the like.

The distillation loss 620 can serve as a feedback metric that can guide the training of the small language model 612 through the adjust small language model operation 622. The adjust small language model operation 622 can be a recursive step. During the adjust small language model operation 622, the small language model 612 parameters can be iteratively updated to minimize the calculated distillation loss 620 between the teacher response 610 and the student response 616. The adjust small language model operation 622 can continue until the small language model 612 achieves sufficient accuracy in emulating the behavior of the large language model 606 within a specialized domain. Through the iterative adjust small language model operation 622, the small language model 612 can evolve into a trained domain-specialized small language model 624 that can capture the knowledge and capability required for the trained domain-specialized small language model 624 to function while maintaining computational efficiency.

Once trained, the trained domain-specialized small language model 624 can be suited for edge device or multi-agent compute environment deployment, as described above. For example, the trained domain-specialized small language model 624 can be distributed across multiple devices in a multi-agent compute environment. The distributed architecture can also support various configuration options for hosting the trained domain-specialized small language model 624 and the expanded knowledge base 148. The various configurations can include a unified deployment where the trained domain-specialized small language model 624 and the expanded knowledge base 148 can reside on the same device, or a fully distributed deployment where the trained domain-specialized small language model 624 and the expanded knowledge base 148 are each hosted on separate devices.

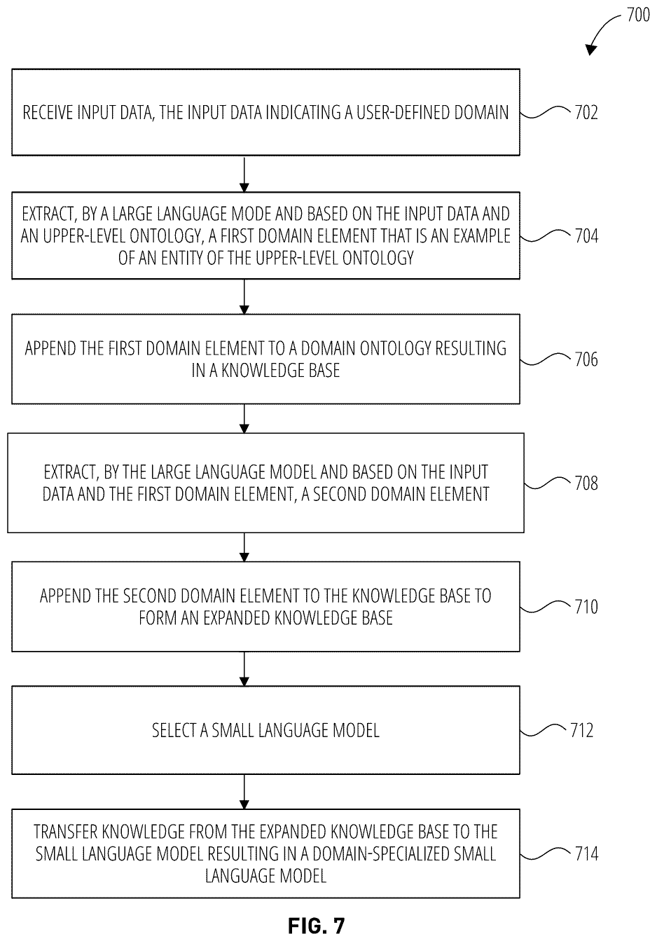

FIG. 7 illustrates by way of example, a flow diagram of an embodiment of a method 700 for knowledge transfer between language models.

The method 700, as illustrated, can include an operation 702 to receive input data, the input data indicating a user-defined domain.

The method 700, as illustrated, can include an operation 704 to extract, by a large language model and based on the input data and an upper-level ontology, a first domain element that is an example of an entity of the upper-level ontology.

The method 700, as illustrated, can include an operation 706 to append the first domain element to a domain ontology resulting in a knowledge base.

The method 700, as illustrated, can include an operation 708 to extract, by the large language model and based on the input data and the first domain element, a second domain element.

The operation 708 can further include, wherein the second domain element includes one or more of an instance, a definition, a class, a property, or a relationship. The operation 708 can further include, wherein the relationship includes one or more of a relationship between the first domain element and the instance, a relationship between the first domain element and the definition, a relationship between the first domain element and the class, or a relationship between the first domain element and the property.

The method 700, as illustrated, can include an operation 710 to append the second domain element to the knowledge base to form an expanded knowledge base.

The method 700, as illustrated, can include an operation 712 to select a small language model. The operation 712 can further include, wherein a parameter count of the large language model exceeds a parameter count of the small language model by a factor of at least 10.

The method 700, as illustrated, can include an operation 714 to transfer knowledge from the expanded knowledge base to the small language model resulting in a domain-specialized small language model. The operation 714 can further include, wherein to transfer knowledge from the knowledge base to the small language model includes to structure the expanded knowledge base into a retrieval augmented generation (RAG) element; to transform the RAG element into a vector representation for retrieval; to generate, for storing the vector representation, a vector store; to retrieve, in response to a user query, the vector representation; and to augment the small language model with the vector representation to generate a domain-specialized response to the user query. The operation 714 can further include, wherein to transfer knowledge from the knowledge base to the small language model includes: to provide, related to the input date and the expanded knowledge base, a set of training data to the large language model and the small language model; to generate, by using the large language mode, a set of teacher responses; to generate, by using the small language model, a set of student responses; to compute, based on a difference between the set of teacher responses and the set of student responses, a distillation loss; and to adjust the small language model to minimize the distillation loss, resulting in the domain-specialized small language model.

The method 700 can further include to receive, by the domain-specialized language model, a user query; and to generate, based on the expanded knowledge base and by the domain-specialized small language model, a response corresponding to the user query.

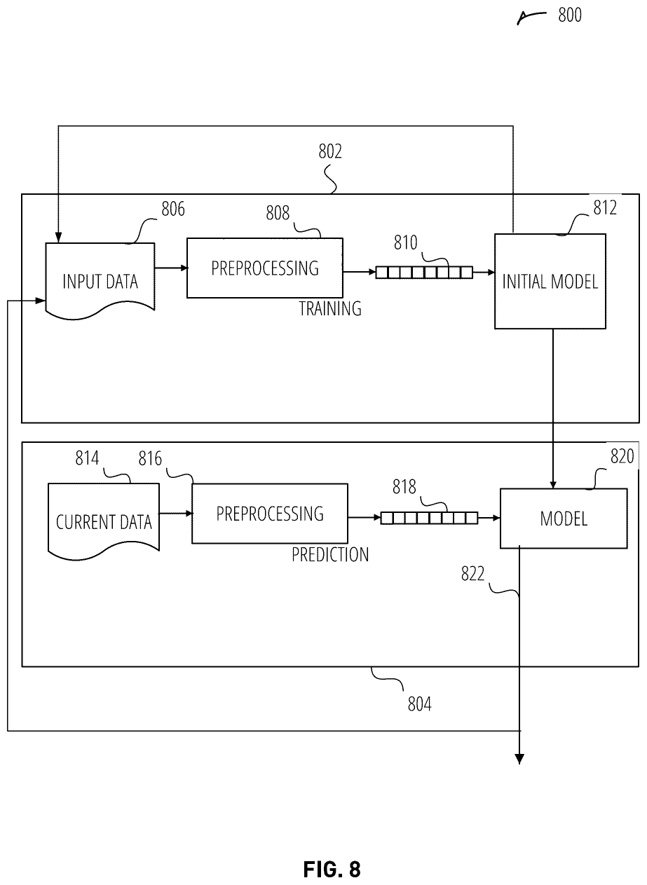

FIG. 8 illustrates a machine learning engine for training a program for knowledge transfer between language models. The machine learning engine may be deployed to execute at a mobile device (e.g., a cell phone, a tablet, etc.) or a computer (e.g., a desktop, a laptop, etc.). FIG. 8 shows an example machine learning engine 800 according to some examples of the present disclosure.

Machine learning engine 800 uses a training engine 802 and a prediction engine 804. Training engine 802 uses input data 806, for example after undergoing preprocessing component 808, to determine one or more features 810. The one or more features 810 can be used to generate an initial model 812, which can be updated iteratively or with future labeled or unlabeled data (e.g., during reinforcement learning), for example to improve the performance of the prediction engine 804 or the initial model 812. An improved model can be redeployed for use.

The input data 806 can include data sets, such as, a knowledge base 132, an expanded knowledge base 148, training data 604, or prompts 116.

In the prediction engine 804, current data 814 (e.g., prompts 116, knowledge base 132, expanded knowledge base 148, or training data 604) can be input to preprocessing component 816. In some examples, preprocessing components 816 and preprocessing component 808 are the same. The prediction engine 804 produces feature vector 818 from the preprocessed current data, which is input into the model 820 to generate one or more criteria weightings 822. The criteria weightings 822 can be used to output a prediction, as discussed further below.

The training engine 802 can operate in an offline manner to train the model 820 (e.g., on a server). The prediction engine 804 can be designed to operate in an online manner (e.g., in real-time, at a mobile device, on a wearable device, etc.). In some examples, the model 820 can be periodically updated via additional training (e.g., via updated input data 806 or based on labeled or unlabeled data output in the criteria weightings 822) or based on identified future data, such as by using reinforcement learning to personalize a general model (e.g., the initial model 812) to a particular user.

Labels for the input data 806 can include close relationship with an output of the large language model, or not a close relationship with an output of the large language model.

The initial model 812 can be updated using further input data 806 until a satisfactory model 820 is generated. The model 820 generation can be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 802 can be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 802. In an example embodiment, a regression model is used and the model 820 is a vector of coefficients corresponding to a learned importance for each of the features in the vector of features 810, 818. A reinforcement learning model can use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 820 may output a domain-specialized response to a user query.

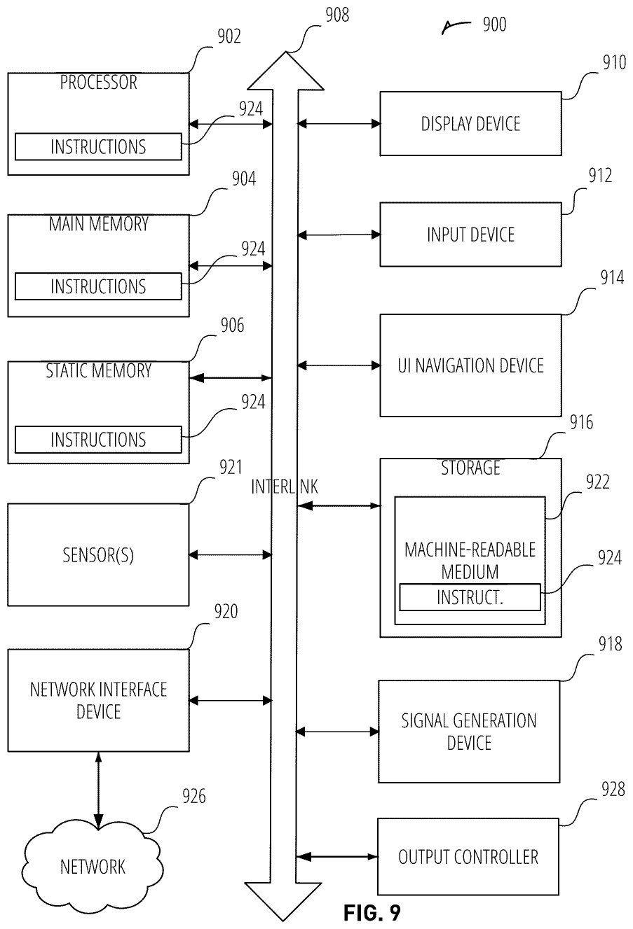

FIG. 9 illustrates generally an example of a block diagram of a machine upon which any one or more of the techniques discussed herein can perform in accordance with at least one example of this disclosure. This example machine can operate some or all of the knowledge base generation process 100, knowledge transfer process through inference 500, knowledge transfer process through training 600, method 700, or machine learning engine 800 discussed herein. In some examples, the knowledge base generation process 100, knowledge transfer process through inference 500, knowledge transfer process through training 600, method 700, or machine learning engine 800 can operate on the example machine 900. In other examples, the example machine 900 is merely one of many such machines used to operate the orthopedic surgical planning system. In alternative embodiments, the example machine 900 can operate as a standalone device or can be connected (e.g., networked) to other machines. In a networked deployment, the example machine 900 can operate in the capacity of a server machine, a client machine, or both in server-client network environments. In an example, the example machine 900 can act as a peer machine in peer-to-peer (P2P) (or other distributed) network environment. The example machine 900 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 900 can include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The example machine 900 can further include a display device 910, an alphanumeric input device 912 (e.g., a keyboard), and a user interface UI navigation device 914 (e.g., a mouse). In an example, the display device 910, input device 912 and UI navigation device 914 can be a touch screen display. The machine 900 can additionally include a storage device 916 (e.g., drive unit), a signal generation device 918 (e.g., a speaker), a network interface device 920, and one or more sensors 921, such as a global positioning system (GPS) sensor, compass, accelerometer, or other sensor. The machine 900 can include an output controller 928, such as a serial (e.g., Universal Serial Bus (USB), parallel, or other wired or wireless (e.g., infrared (IR), near field communication (NFC), etc.) connection to communicate or control one or more peripheral devices (e.g., a printer, card reader, etc.).

The storage device 916 can include a machine readable machine-readable medium 922 on which is stored one or more sets of data structures or instructions 924 (e.g., software) embodying or utilized by any one or more of the techniques or functions described herein. The instructions 924 can also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 can constitute machine readable media.

While the machine-readable medium 922 is illustrated as a single medium, the term “machine readable medium” can include a single medium or multiple media (e.g., a centralized or distributed database, or associated caches and servers) configured to store the one or more instructions 924. The term “machine readable medium” can include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples can include solid-state memories, and optical and magnetic media.

The instructions 924 can further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 702.11 family of standards known as Wi-Fi®, IEEE 502.16 family of standards known as WiMax®), IEEE 702.15.4 family of standards, peer-to-peer (P2P) networks, among others. In an example, the network interface device 920 can include one or more physical jacks (e.g., Ethernet, coaxial, or phone jacks) or one or more antennas to connect to the communications network 926. In an example, the network interface device 920 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900, and includes digital or analog communications signals or other intangible medium to facilitate communication of such software.

### Examples and Additional Notes

Example 1 is a method for knowledge transfer between language models, comprising: receiving input data, the input data indicating a user-defined domain; extracting, by a large language model and based on the input data and an upper-level ontology, a first domain element that is an example of an entity of the upper-level ontology; appending the first domain element to a domain ontology resulting in a knowledge base; extracting, by the large language model and based on the input data and the first domain element, a second domain element; appending the second domain element to the knowledge base to form an expanded knowledge base; selecting a small language model; and transferring knowledge from the expanded knowledge base to the small language model resulting in a domain-specialized small language model.

In Example 2, the subject matter of Example 1 includes, wherein the second domain element includes one or more of an instance, a definition, a class, a property, or a relationship.

In Example 3, the subject matter of Example 2 includes, wherein the relationship includes one or more of a relationship between the first domain element and the instance, a relationship between the first domain element and the definition, a relationship between the first domain element and the class, or a relationship between the first domain element and the property.

In Example 4, the subject matter of Examples 1-3 includes, wherein transferring knowledge from the knowledge base to the small language model includes: structuring the expanded knowledge base into a retrieval augmented generation (RAG) element; transforming the RAG element into a vector representation for retrieval; generating, for storing the vector representation, a vector store; retrieving, in response to a user query, the vector representation; and augmenting the small language model with the vector representation to generate a domain-specialized response to the user query.

In Example 5, the subject matter of Examples 1-4 includes, wherein transferring knowledge from the knowledge base to the small language model includes: providing, related to the input data and the expanded knowledge base, a set of training data to the large language model and the small language model; generating, by using the large language model, a set of teacher responses; generating, by using the small language model, a set of student responses; computing, based on a difference between the set of teacher responses and the set of student responses, a distillation loss; and adjusting the small language model to minimize the distillation loss, resulting in the domain-specialized small language model.

In Example 6, the subject matter of Examples 1-5 includes, receiving, by the domain-specialized small language model, a user query; and generating, based on the expanded knowledge base and by the domain-specialized small language model, a response corresponding to the user query.

In Example 7, the subject matter of Examples 1-6 includes, wherein a parameter count of the large language model exceeds a parameter count of the small language model by a factor of at least 10.

Example 8 is a system comprising: processing circuitry; and a memory device including instruction stored thereon that, when executed by a machine, cause the machine to perform operations for knowledge transfer between language models, the operations comprising: receiving input data, the input data indicating a user-defined domain; extracting, by a large language model and based on the input data and an upper-level ontology, a first domain element that is an example of an entity of the upper-level ontology; appending the first domain element to a domain ontology resulting in a knowledge base; extracting, by the large language model and based on the input data and the first domain element, a second domain element; appending the second domain element to the knowledge base to form an expanded knowledge base; selecting a small language model; and transferring knowledge from the expanded knowledge base to the small language model resulting in a domain-specialized small language model.

In Example 9, the subject matter of Example 8 includes, wherein the second domain element includes one or more of an instance, a definition, a class, a property, or a relationship.

In Example 10, the subject matter of Example 9 includes, wherein the relationship includes one or more of a relationship between the first domain element and the instance, a relationship between the first domain element and the definition, a relationship between the first domain element and the class, or a relationship between the first domain element and the property.

In Example 11, the subject matter of Examples 8-10 includes, wherein transferring knowledge from the knowledge base to the small language model includes: structuring the expanded knowledge base into a retrieval augmented generation (RAG) element; transforming the RAG element into a vector representation for retrieval; generating, for storing the vector representation, a vector store; retrieving, in response to a user query, the vector representation; and augmenting the small language model with the vector representation to generate a domain-specialized response to the user query.

In Example 12, the subject matter of Examples 8-11 includes, wherein transferring knowledge from the knowledge base to the small language model includes: providing, related to the input data and the expanded knowledge base, a set of training data to the large language model and the small language model; generating, by using the large language model, a set of teacher responses; generating, by using the small language model, a set of student responses; computing, based on a difference between the set of teacher responses and the set of student responses, a distillation loss; and adjusting the small language model to minimize the distillation loss, resulting in the domain-specialized small language model.

In Example 13, the subject matter of Examples 8-12 includes, receiving, by the domain-specialized small language model, a user query; and generating, based on the expanded knowledge base and by the domain-specialized small language model, a response corresponding to the user query.

In Example 14, the subject matter of Examples 8-13 includes, wherein a parameter count of the large language model exceeds a parameter count of the small language model by a factor of at least 10.

Example 15 is a non-transitory machine-readable medium including instructions that, when executed by a machine, cause the machine to perform operations for knowledge transfer between language model, the operations comprising: receiving input data, the input data indicating a user-defined domain; extracting, by a large language model and based on the input data and an upper-level ontology, a first domain element that is an example of an entity of the upper-level ontology; appending the first domain element to a domain ontology resulting in a knowledge base; extracting, by the large language model and based on the input data and the first domain element, a second domain element; appending the second domain element to the knowledge base to form an expanded knowledge base; selecting a small language model; and transferring knowledge from the expanded knowledge base to the small language model resulting in a domain-specialized small language model.

In Example 16, the subject matter of Example 15 includes, wherein the second domain element includes one or more of an instance, a definition, a class, a property, or a relationship.

In Example 17, the subject matter of Example 16 includes, wherein the relationship includes one or more of a relationship between the first domain element and the instance, a relationship between the first domain element and the definition, a relationship between the first domain element and the class, or a relationship between the first domain element and the property.

In Example 18, the subject matter of Examples 15-17 includes, wherein transferring knowledge from the knowledge base to the small language model includes: structuring the expanded knowledge base into a retrieval augmented generation (RAG) element; transforming the RAG element into a vector representation for retrieval; generating, for storing the vector representation, a vector store; retrieving, in response to a user query, the vector representation; and augmenting the small language model with the vector representation to generate a domain-specialized response to the user query.

In Example 19, the subject matter of Examples 15-18 includes, wherein transferring knowledge from the knowledge base to the small language model includes: providing, related to the input data and the expanded knowledge base, a set of training data to the large language model and the small language model; generating, by using the large language model, a set of teacher responses; generating, by using the small language model, a set of student responses; computing, based on a difference between the set of teacher responses and the set of student responses, a distillation loss; and adjusting the small language model to minimize the distillation loss, resulting in the domain-specialized small language model.

In Example 20, the subject matter of Examples 15-19 includes, receiving, by the domain-specialized small language model, a user query; and generating, based on the expanded knowledge base and by the domain-specialized small language model, a response corresponding to the user query.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instance or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for knowledge transfer between language models, comprising:
receiving input data, the input data indicating a user-defined domain;
extracting, by a large language model and based on the input data and an upper-level ontology, a first domain element that is an example of an entity of the upper-level ontology;
appending the first domain element to a domain ontology resulting in a knowledge base;
extracting, by the large language model and based on the input data and the first domain element, a second domain element;
appending the second domain element to the knowledge base to form an expanded knowledge base;
selecting a small language model; and
transferring knowledge from the expanded knowledge base to the small language model resulting in a domain-specialized small language model.

2. The method of claim 1, wherein the second domain element includes one or more of an instance, a definition, a class, a property, or a relationship.

3. The method of claim 2, wherein the relationship includes one or more of a relationship between the first domain element and the instance, a relationship between the first domain element and the definition, a relationship between the first domain element and the class, or a relationship between the first domain element and the property.

4. The method of claim 1, wherein transferring knowledge from the knowledge base to the small language model includes:
structuring the expanded knowledge base into a retrieval augmented generation (RAG) element;
transforming the RAG element into a vector representation for retrieval;
generating, for storing the vector representation, a vector store;
retrieving, in response to a user query, the vector representation; and
augmenting the small language model with the vector representation to generate a domain-specialized response to the user query.

5. The method of claim 1, wherein transferring knowledge from the knowledge base to the small language model includes:
providing, related to the input data and the expanded knowledge base, a set of training data to the large language model and the small language model;
generating, by using the large language model, a set of teacher responses;
generating, by using the small language model, a set of student responses;
computing, based on a difference between the set of teacher responses and the set of student responses, a distillation loss; and
adjusting the small language model to minimize the distillation loss, resulting in the domain-specialized small language model.

6. The method of claim 1, comprising:
receiving, by the domain-specialized small language model, a user query; and
generating, based on the expanded knowledge base and by the domain-specialized small language model, a response corresponding to the user query.

7. The method of claim 1, wherein a parameter count of the large language model exceeds a parameter count of the small language model by a factor of at least 10.

8. A system comprising:
processing circuitry; and
a memory device including instruction stored thereon that, when executed by a machine, cause the machine to perform operations for knowledge transfer between language models, the operations comprising:
receiving input data, the input data indicating a user-defined domain;
extracting, by a large language model and based on the input data and an upper-level ontology, a first domain element that is an example of an entity of the upper-level ontology;
appending the first domain element to a domain ontology resulting in a knowledge base;
extracting, by the large language model and based on the input data and the first domain element, a second domain element;
appending the second domain element to the knowledge base to form an expanded knowledge base;
selecting a small language model; and
transferring knowledge from the expanded knowledge base to the small language model resulting in a domain-specialized small language model.

9. The system of claim 8, wherein the second domain element includes one or more of an instance, a definition, a class, a property, or a relationship.

10. The system of claim 9, wherein the relationship includes one or more of a relationship between the first domain element and the instance, a relationship between the first domain element and the definition, a relationship between the first domain element and the class, or a relationship between the first domain element and the property.

11. The system of claim 8, wherein transferring knowledge from the knowledge base to the small language model includes:
structuring the expanded knowledge base into a retrieval augmented generation (RAG) element;
transforming the RAG element into a vector representation for retrieval;
generating, for storing the vector representation, a vector store;
retrieving, in response to a user query, the vector representation; and
augmenting the small language model with the vector representation to generate a domain-specialized response to the user query.

12. The system of claim 8, wherein transferring knowledge from the knowledge base to the small language model includes:
providing, related to the input data and the expanded knowledge base, a set of training data to the large language model and the small language model;
generating, by using the large language model, a set of teacher responses;
generating, by using the small language model, a set of student responses;
computing, based on a difference between the set of teacher responses and the set of student responses, a distillation loss; and
adjusting the small language model to minimize the distillation loss, resulting in the domain-specialized small language model.

13. The system of claim 8, comprising:
receiving, by the domain-specialized small language model, a user query; and
generating, based on the expanded knowledge base and by the domain-specialized small language model, a response corresponding to the user query.

14. The system of claim 8, wherein a parameter count of the large language model exceeds a parameter count of the small language model by a factor of at least 10.

15. A non-transitory machine-readable medium including instructions that, when executed by a machine, cause the machine to perform operations for knowledge transfer between language model, the operations comprising:
receiving input data, the input data indicating a user-defined domain;
extracting, by a large language model and based on the input data and an upper-level ontology, a first domain element that is an example of an entity of the upper-level ontology;
appending the first domain element to a domain ontology resulting in a knowledge base;
extracting, by the large language model and based on the input data and the first domain element, a second domain element;
appending the second domain element to the knowledge base to form an expanded knowledge base;
selecting a small language model; and
transferring knowledge from the expanded knowledge base to the small language model resulting in a domain-specialized small language model.

16. The non-transitory machine-readable medium of claim 15, wherein the second domain element includes one or more of an instance, a definition, a class, a property, or a relationship.

17. The non-transitory machine-readable medium of claim 16, wherein the relationship includes one or more of a relationship between the first domain element and the instance, a relationship between the first domain element and the definition, a relationship between the first domain element and the class, or a relationship between the first domain element and the property.

18. The non-transitory machine-readable medium of claim 15, wherein transferring knowledge from the knowledge base to the small language model includes:
structuring the expanded knowledge base into a retrieval augmented generation (RAG) element;
transforming the RAG element into a vector representation for retrieval;
generating, for storing the vector representation, a vector store;
retrieving, in response to a user query, the vector representation; and
augmenting the small language model with the vector representation to generate a domain-specialized response to the user query.

19. The non-transitory machine-readable medium of claim 15, wherein transferring knowledge from the knowledge base to the small language model includes:
providing, related to the input data and the expanded knowledge base, a set of training data to the large language model and the small language model;
generating, by using the large language model, a set of teacher responses;
generating, by using the small language model, a set of student responses;
computing, based on a difference between the set of teacher responses and the set of student responses, a distillation loss; and
adjusting the small language model to minimize the distillation loss, resulting in the domain-specialized small language model.

20. The non-transitory machine-readable medium of claim 15, comprising:
receiving, by the domain-specialized small language model, a user query; and
generating, based on the expanded knowledge base and by the domain-specialized small language model, a response corresponding to the user query.
